(19) United States
(12) Patent Application Publication
(10) Pub. No.: US 2024/0270361 A1
(43) Pub. Date: Aug. 15, 2024

(54) SAIL PROPULSION ELEMENT, SAIL-PROPELLED VEHICLE

(71) Applicant: COMPAGNIE GENERALE DES ETABLISSEMENTS MICHELIN, Clermont-Ferrand (FR)

(72) Inventors: OLIVIER ESSINGER, Clermont-Ferrand (FR); BRUNO FRAGNIERE, Clermont-Ferrand (FR); EDOUARD KESSI, ST-PREST (CH); LAURENT DE KALBERMATTEN, Riaz (CH)

(21) Appl. No.: 18/564,765

(22) PCT Filed: May 30, 2022
(86) PCT No.: PCT/FR2022/051019

§ 371 Date: Nov. 28, 2023

(30) Foreign Application Priority Data
May 28, 2021 (FR) FR2105610

(51) Int. Cl. B63H 9/061; B63B 35/00

(52) U.S. Cl. CPC B63H 9/0615; B63B 35/00; B63B 2035/009

(57) ABSTRACT

A sail propulsion element comprises a mast (3), an inflatable or non-inflatable sail (1) consisting essentially of two substantially fluidtight adjacent surfaces (5) joined together along their periphery, thus forming at least one closed cavity between them, an air conduit positioned between the inside and the outside of the cavity, at least one means for injecting air into the cavity, the sail once inflated having a profile that remains permanently symmetrical, irrespective of the movement of the propulsion element, or of the direction or strength of the wind, a headboard (10), and a sail receptacle (11). The mast is located forward of the center of aerodynamic thrust of the sail, the mast is or is not free to rotate by 360°, and the sail comprises at least one means maintaining a slight pressure in the sail.

The invention relates to an inflatable sail, and falls within the field of sail propulsion or that of hybrid sail propulsion.

A reminder of some definitions used hereinafter is given below:
Reefing: consists in reducing the surface area of a sail by partly furling it from the bottom so as to adapt the surface area of the sail to suit the strength of the wind. The reefing may be done manually or automatically.
Reefing bands: partially reinforced horizontal zones to which reefing turning blocks can be attached, with, for example, grommets or pulleys These reefing bands are positioned on the sail at the rib at each height at which the sail has a reefing point. There are as many reefing bands as there are possibilities to reef the surface area of the sail.
Lazy jacks: devices for guiding the sail to carry out the operations of reefing and of dropping the sail.
Boom: horizontal spar articulated close to the base of the mast and which holds and permits orientation of certain sails. The boom may also receive the sail when the sail has been dropped.
Luffing: a sail which is luffing is insufficiently hauled in and has therefore partially deflated. A well-trimmed sail needs to be on the limit of luffing. With a properly filled sail there is no luffing so it is possible to sail close to the wind.
Leading edge: the front part of a dynamic profile (wing, propeller, etc.) at which a fluid will divide into two streams.
Trailing edge: a characteristic part of any profile (wing, keel, rudder blade, etc.) subjected to a flow of a fluid (air, water, etc.) on each side of it. It designates the part opposite to the sense of direction or, in other words, the rear part when considered in the direction of the flow.
Headboard: the upper end of the sail which conforms to the upper contour of the inflatable sail.
Dropping: consists in lowering the sail.
Hoisting: consists in raising the sail.
Rigging: collection of fixed and moving parts of a boat of the sailboat type that allows the boat to be propelled and manoeuvred using the force of the wind.
Sail receptacle: in addition to receiving the dropped sail, it may incorporate other functions, such as reacting the tension supplied by the sail, or else housing other actuators, energy storage sensors and control module used for operating the sail.
Hydrodynamic drag: the force of friction between the boat and the water. The higher the drag, the more the boat is slowed.
Aerodynamic drag: a component of the force experienced by a body moving through a fluid and that is exerted in the opposite direction to the direction of the movement. According to the invention, the sail generates aerodynamic drag.
Aerodynamic lift: a component of the force experienced by a body moving through a fluid and that is exerted perpendicular to the direction of the movement. According to the invention, the sail generates aerodynamic lift.
Relative wind or apparent wind: the vector sum of the wind created by the inherent speed of the boat and the actual windspeed.
Aerodynamic resultant: the vector sum of the aerodynamic lift and of the aerodynamic drag.
Angle of incidence of the sail: angle between the plane of the sail profile and the direction of the relative wind.
Angle of the sail: angle between the plane of the sail profile and the axis of the boat.

### PRIOR ART

A sail propulsion element comprising an inflatable sail with a symmetrical profile is already known from document WO 2017/221117A1. This propulsion element comprises an inflatable sail consisting essentially of two substantially fluidtight adjacent surfaces joined together along their periphery, thus forming at least one closed cavity. The element further comprises a conduit positioned between the inside and the outside of the cavity and means for injecting air into the cavity. Once inflated, this sail has a profile that remains permanently symmetrical, irrespective of movement of the element, or of the direction or strength of the wind. The sail in that document is constantly being inflated while it is being used for sailing.

Unfortunately, a soft sail such as this has the disadvantage of not offering a level of inflation that is suited to the various stages of its use, notably during the hoisting and dropping phases. Specifically, unlike a hard sail, a soft sail has no clearly defined position for these stages of handling (hoisting and dropping). During these stages, it is important to keep the sail close to the axis of symmetry of the sail profile, so as to avoid the sail falling in the water or becoming caught on an element close by, or collapsing in an ill-defined heap such that it cannot be stowed compactly. Moreover, it is important to maintain a slight pressure in the sail during the dropping or reefing phase, so as to prevent it from luffing, as this could reduce its life.

Furthermore, the sail described in this document cannot be secured correctly when the automatic sail-handling device, namely the controls, sensors, actuators or electrical-energy supply parts, suffers an electronic or electrical breakdown.

A device for the hydraulic regulation of retractable boat sails is also known from document CN107878720A. The sail is made of two parts, a lower part and an upper part, which are able to rotate independently of one another around the mast, depending on the sailing conditions or the wind direction. This device automatically adjusts the angle of attack of each of the two parts of the sail according to the wind. The retractability of the sails ensures the safety of the boat under poor sailing conditions. However, the retractability of the sail requires the electronic automation devices to work correctly. No alternative is offered in case of breakdown.

### SUMMARY OF THE INVENTION

Thus there is still a need for a continuously or not-continuously inflatable sail, or else a non-inflatable sail, or else a taut sail, or else a hard sail with an asymmetric profile which, in the event of an electronic breakdown with its automatic handling device, is able to remain in a safe position which is safe both for the sail and for the sailors on board, while at the same time minimizing the forces generated by the lift of this inflatable sail. To achieve that, the sail needs to be able to position itself facing into the wind (and/or be positioned through manual means) so as to very greatly decrease the creation of aerodynamic lift but have only aerodynamic drag. This makes it possible to reduce the forces on the rigging and on the boat, and also operate in complete safety.

One subject matter of the invention is a sail propulsion element, comprising a mast, an inflatable or non-inflatable sail consisting essentially of two substantially fluidtight adjacent surfaces joined together along their periphery, thus forming at least one closed cavity between them, said sail comprising an upper part, a lower part, a leading edge and a trailing edge, the sail comprising various cambers forming bulges along its entire length, an air conduit positioned between the inside and the outside of the cavity of the sail, at least one means for injecting air into said cavity, the sail once inflated having a profile that remains permanently symmetrical, irrespective of the movement of said propulsion element, or of the direction or strength of the wind, a headboard positioned on the upper part of the sail, and a sail receptacle positioned between the leading edge and the trailing edge on the lower part of the sail.

The propulsion element according to the invention is characterized in that the mast is located forward of the centre of aerodynamic thrust of the sail, in that the mast is or is not free to rotate by 360°, and in that the sail comprises at least one means maintaining a slight pressure in the sail.

As a preference, according to the invention, the mast is made to rotate by a system for adjusting the angle of incidence of the sail and is able to be free to rotate in the event of the mast ceasing to be driven by said system. Thus, the mast is made to rotate using an automatic handling system which acts on the system that adjusts the angle of incidence of the sail and, in the event of a breakdown or an incident or even if the automatic handling system is deliberately stopped from operating, the mast is left with the freedom to rotate. The mast can thus rotate several times on itself. An incident or a breakdown means for example the loss of electrical power to the mast-driving motor or to the electronic components of the automatic handling system, or even the mast rotation torque reaching a preestablished limit value. In such instances, the mast is left free to rotate, so that the sail can be positioned facing into the wind thus reducing the forces on the rigging and on the boat.

The sail propulsion element according to the invention offers the following various advantages. The centre of aerodynamic thrust is clearly distinct from the mast, and is sufficiently distanced therefrom toward the stern of the boat. Positioning the mast forward of the centre of aerodynamic thrust of the sail means that the resultant of the aerodynamic forces on the sail in all circumstances brings the sail to face into the relative wind, except when the relative wind is nil. Furthermore, keeping the sail in a sufficiently inflated position thanks to the passive air inlets situated, for example, on the leading edge, allows the sail to maintain its profile, thus preventing it from luffing even with no active supply. In situations in which the relative wind is nil (thus preventing the sail from being inflated), the sail will not luff. In such an electronic breakdown situation, the luffing of the sail would cause the sail to crack (in the sense of slapping) which would therefore create significant loadings carrying the risk of destroying the sail or the mast. Finally, in the case of an electronic breakdown, the possibility of very quickly and easily using the sail in manual mode enhances the ability to make it safe, and therefore safeguard the boat and its crew.

As a preference, the centre of aerodynamic thrust of the sail is distant from the mast by a length ranging from 0 to 10 m.

As a preference, the means for maintaining pressure is an air intake opening positioned facing into the relative wind. This air intake makes it possible to maintain in the sail an internal pressure that is maintained by the relative wind.

As a preference, during said rotation of the mast energy and commands are transmitted using a device that does not impede said rotation.

As a preference, the device that does not impede the rotation is selected from a rotary joint or a cable bearing chain if it is accepted that the freedom to rotate will not be infinite but limited to a number of revolutions.

As a preference, the air intake opening comprises a mobile closure flap.

As a preference, at least one guide line consisting of one or more parts is positioned in the closed cavity of said sail, for the manoeuvres of hoisting and dropping the sail, said guide line extending from the leading edge to the trailing edge of said sail, passing through the headboard and the sail receptacle.

As a preference, when a guide line is present, it consists of one part and is attached fixedly to the sail receptacle on the trailing edge and able to be moved by a roller on the leading edge, or else is able to be moved by a roller in the sail receptacle on the trailing edge and fixedly attached to the leading edge, and the guide line is positioned along the headboard such as to be able to move over at least one pulley between the trailing edge and the leading edge.

As a preference, when a guide line is present, it consists of two parts, the first part on the side of the trailing edge is fixed or else able to be moved with a pulley on the headboard and able to be moved by a roller in the receptacle, the second part on the side of the leading edge is fixed or else able to be moved with a pulley on the headboard and able to be moved by a roller in the receptacle.

Another subject matter of the present invention is a vehicle with sail or hybrid propulsion comprising at least one sail-propulsion element as mentioned hereinabove, a hull and a mast secured to said hull but still free to rotate. This vehicle is characterized in that the mast is positioned inside the cavity of the above-mentioned inflatable sail.

What is meant by a vehicle is any craft, with or without wheels, moving over land, water, ice, snow or mud.

As a preference, the sail is oriented according to the direction of the wind, and the direction of travel of the vehicle manually or automatically so as to optimize the thrust along the axis of the boat or to achieve the desired thrust, while at the same time limiting the forces, pressures and heel to acceptable values.

When the mast is not free to rotate infinitely, it may simply, for example, make two revolutions upon itself, in one direction, without jamming, by use of a cable bearing chain. In such instances, it will then have to rotate in the opposite direction in order to return to a correct position for sailing.

What is meant by a hybrid-propulsion vehicle according to the invention is sail propulsion coupled with another source of propulsion such as, for example, propulsion by means of a propeller driven by an electric motor or a combustion engine, having, as energy store, batteries, hydrogen (with fuel cell), natural gas or fuel oil.

### DESCRIPTION OF THE DRAWINGS

The invention will be described with the aid of the following figures, which are schematic and not necessarily drawn to scale, and in which:

FIG. 1 provides a reminder of the various physical forces that are applied to a ship, for example of the motor sailboat type, and notably the projection of the resultant aerodynamic force;

FIG. 2 depicts a schematic view in cross section of the sail-propulsion element according to the invention, positioned on a boat hull,

FIGS. 3A, 3B and 3C each depict a schematic view from above of the position of the propulsion element according to the invention according to different relative-wind angles.

Before the sail-propulsion element that forms the subject matter of the present invention is explained in greater detail, with the aid of the above-mentioned figures, a reminder of a few hydrodynamic and aerodynamic definitions is given below.

A sail-propulsion vehicle, hereinafter referred to as sailboat or ship, is in contact with the air and with the water. From a physical standpoint, the predominant factors are the hydrodynamic and aerodynamic forces that are applied to the hull, the sails and the appendages (centreboards, keel, rudder), propeller.

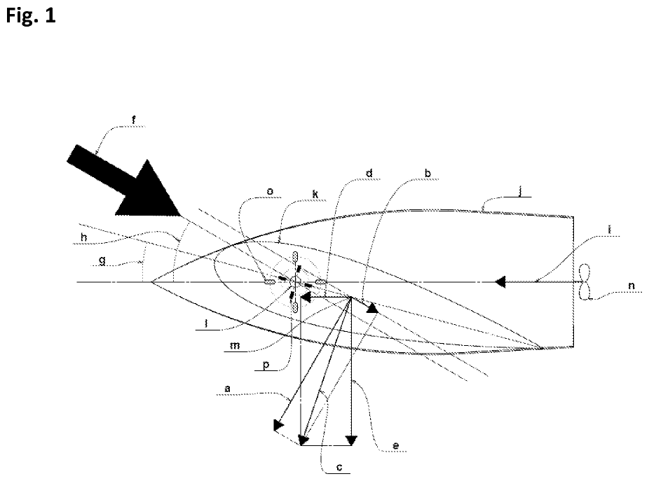

As shown in FIG. 1, the aerodynamic force (or sail thrust) is the result of the air being deflected by at least one sail. The aerodynamic force is relative to the sail and to the position and strength of the relative wind. The drag force is in the direction of the relative wind, the lift force is in the direction perpendicular to the relative wind, and is not always perpendicular to the sail. For example, at 0°, a symmetrical profile creates no lift because the air covers strictly the same distance over the extrados surface and the intrados surface. At that point, it generates only drag.

The aerodynamic force generated by the sail may also be broken down in the frame of reference of the boat, rather than that of the sail, into a sail-propulsion force (along the axis of travel of the boat) and a drift force (perpendicular to the axis of the boat) which may cause a boat to heel (heeling being the transverse inclination of a boat as caused by an external phenomenon such as the wind).

The hydrodynamic force is the result of the friction of the water against the hull and the centreboard or keel and the various underwater appendages. Its direction is dependent on the aerodynamic force that it opposes, on the propulsion force in hybrid mode, on the sea state and on the marine currents. The longitudinal component is referred to as hydrodynamic drag and the transverse component is referred to as side force, anti-heeling force or hydrodynamic lift. The direction and the intensity of the hydrodynamic force are not dependent solely on the aerodynamic force. For a surface vessel (boat) operating in hybrid mode (wind and another energy source), the hydrodynamic force will be greatly dependent on the vessel speed generated by the engine or motor propulsion, for example, on the sea state and on the marine currents.

When the sail force is greater than the hydrodynamic force, the boat accelerates. When the sail force is lower than the hydrodynamic force, the boat slows down. Further, if the aerodynamic force is greater, but directed towards the rear of the boat, the boat will slow down. If the hydrodynamic force is in the direction of travel of the boat (because there is a strong current), the boat (sailboat) will accelerate.

It is by optimizing the trim of the sail that the boat (sailboat) will achieve its maximum performance in terms of sail thrust in the direction of travel. Specifically, it is by optimizing the angle of the sail relative to the relative wind, to the direction of the boat and by trimming the surface area of the sail, that the boat can be made to achieve the maximum level of sail propulsion along the axis of the boat. Added to this there may be an additional trimming involving altering the internal pressure of the sail. This then makes it possible to increase the speed of the boat or, on the other hand, to maintain the same speed while at the same time reducing the consumption of other energy sources, in favour of sail power.

FIG. 1 repeats each of the foregoing defined parameters with its own specific reference, all as listed hereinbelow:
a: Lift force
b: Drag force
c: Aerodynamic resultant force
d: Aerodynamic thrust force (along the axis of the ship)
e: Aerodynamic drift force
f: Relative wind
g: Relative angle between wing and boat axis (e.g. 15°)
h: Angle between relative wind and boat axis (e.g. 30°)
i: Propeller propulsion force
j: Hull
k: Sail
l: Mast
m: Centre of aerodynamic thrust
n: Propeller
o: sensor on fixed part (hull frame of reference)
p: sensor on moving part (sail frame of reference)
   The information given in FIG. 1 allows transition from sensors of data in the frame of reference of the hull to the sensors of data in the frame of reference of the sail, and vice versa.

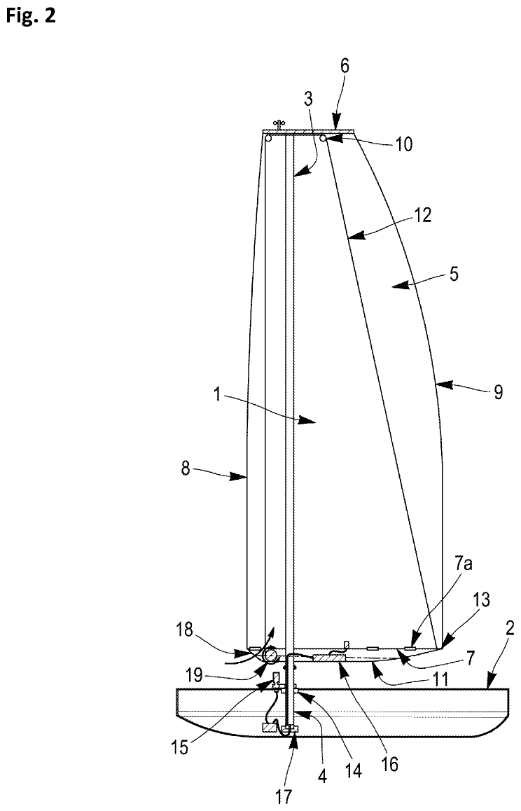

FIG. 2 depicts the sail propulsion element according to the invention, mounted on a boat, of the sailboat type, in the position of operation. This element comprises a sail of overall reference 1 mounted on the hull 2 of a boat. The element comprises a mast 3 of which the foot 4 is fixed to the hull 2, while still allowing the mast 3 a rotational movement. The mast 3 is self-supporting. The mast 3 is connected to the hull 2 using a support (not depicted) intended to absorb the load of the physical force and leave a degree of freedom to rotate. Loads are measured at the support(s). The sail 1 comprises two adjacent surfaces 5 (only one can be seen in the figure) connected to one another in such a way as to form a closed cavity. The material used for the two adjacent surfaces 5 needs to limit permeation so as to reduce air consumption and thus allow the various loads involved to be reacted and transmitted. In certain cases it may be necessary to add various treatments to the material so as to ensure, for example, a certain fire or UV resistance or else to apply an antistatic treatment.

The sail 1 has several cambers (not depicted) evenly distributed over the height (the cambers are greater in the lower part of the sail and smaller in the upper part). The height of the camber is often linked to the length of the cord of the profile.

The cambers give it the external appearance of a concertina. The sail 1 comprises an upper part 6, a lower part 7, a leading edge 8 and a trailing edge 9. At least one air inlet 18 is positioned, for example, at the lower part 7 of the sail 1. Other air inlets 30 may also be positioned on the surface of the leading edge 8. At least one active means 7a for injecting air into the cavity of the sail is positioned in the continuation of the air conduit so that air can be injected into the cavity of the sail. The sail further comprises a headboard 10 positioned on its upper part 6, and the sail receptacle 11 positioned on its lower part 7 between the leading edge 8 and the trailing edge 9. This receptacle 11 is intended to receive all or part of the sail when it is dropped. This receptacle 11 may comprise various actuators and sensors facilitating the manual or automatic manoeuvre of hoisting or dropping the sail 1.

The sail propulsion element according to the invention comprises a guide line 12 positioned inside the cavity of the sail 1. This guide line is intended for guiding the sail during the manoeuvres of hoisting and of dropping, and of reefing the sail 1. This line 12 extends substantially over the perimeter of the sail 1. The guide line 12 is fixed removably or non-removably, but such that it is not able to move, at an end 13 situated close to the intersection between the trailing edge 9 and the sail receptacle 11. It then extends towards the upper part 6 of the sail 1, to run along the headboard 10 between the trailing edge 9 and the leading edge 8. The guide line 12 is able to move along the headboard 10 with the aid of at least two pulleys or other possible turning-block systems (which have not been depicted), each one positioned one each side of the mast 3. This guide line 12 is adjacent to the leading edge 8, towards the sail receptacle 11, and is then fixed using a roller 19 on the sail receptacle 11 substantially at the leading edge 8. The guide line 12 may be brought up towards a fastening-off cleat, if it is actuated manually. On the other hand, for the automated version, it is wound onto an automatic roller.

The guide line 12 has a length of around 50 m for a sail having a total surface area of around 100 m², and a tension of between around 50 and 250N depending on the uses to which it is being put during the various dropping and hoisting manoeuvres.

The mast 3 may be telescopic or fixed. When the mast 3 is telescopic, the headboard 10 is secured to the last element of the telescopic mast 3, able to maintain a degree of freedom to rotate, either with respect to the mast or with the last element of the mast which rotates. When the mast 3 is telescopic, it is made up of various elements which slide successively with respect to one another in order to extend or retract. If there is no reefing (in the case of transport ships), it is possible for the elements that form the telescopic mast to be extended one after the other, or all at the same time.

When the mast 3 is fixed, only the headboard 10 is able to move along the mast 3. The sail 1, being fixed to the headboard 10, is raised or lowered therewith. The headboard may be free to rotate, prevented from rotating or prevented from rotating up to a certain load value. It is also possible to have feedback-control of the angular position of the headboard so as to control the twisting of the sail. Specifically, because the wind speed is not the same at all altitudes, it may be advantageous to adapt the angle of incidence of the sail at the various altitudes in order to adapt it to suit the different variations in relative wind.

It is also possible to combine a telescopic mast 3 and a headboard 10 that slides along the mast 3.

The headboard 10 has enough rigidity to be able to impart the physical forces there are between the various line ropes and the mast 3 and also to withstand the weight of the sail when the sail is not inflated. According to the various embodiments according to the invention, the headboard 10 may, as desired, be free to rotate about the mast 3, prevented from rotating about the mast 3, prevented from rotating about the mast 3 up to a limiting torque value so as to limit loads to an acceptable value (the maximum acceptable value will depend on the construction of the system and on the parts which are to be protected with this safety system), or alternatively feedback controlled in such a way as to control the twisting of the sail.

The mast 3 is connected, fixed to the hull 2 using a mast support 14 the purpose of which is to react the various physical forces between the sail and the boat while at the same time leaving the mast a degree of freedom to rotate so that it can position itself at the correct angle with respect to the relative wind.

At the foot of the mast 3, at the hull 2, there is a system 15 for adjusting the angle of incidence so as to make it possible to command the sail 1 to rotate by turning the mast 3 and all the manoeuvring components fixed to said mast 3. This system 15 may consist, amongst other things, of a motor. This system 15 allows the sail 1 to be able to rotate about the axis of rotation of the mast 3 and therefore makes it possible to command the desired angle of incidence of the sail 1. This system for setting the angle of incidence may also be mounted fixedly relative to the mast 3, for example on the “nest” (or sail receptacle), with a motor driving, via a pinion, a ring gear fixed to the hull.

It will be recalled that measuring the angle of incidence makes it possible to determine the angular positioning of the sail 1 with respect to the axis of the boat. Such a device allows the sail 1, the hull 2 and the relative wind to be placed in the one same frame of reference, whatever the point at which the wind is measured on the sail 1 or on the hull 2. Such a system simplifies sailing in automatic mode.

The sail propulsion element according to the invention, positioned on the hull of a boat, may also be combined with a torque limiter, positioned at the foot of the mast 3 and known for limiting the maximum torque that the sail 1 can transmit to the hull 2.

The propulsion element according to the invention, positioned on the hull of a boat, may further comprise an electronic control system 16 positioned in the sail receptacle 11. A rotary electrical joint 17 may be added in the hull at the lower base of the mast 3. This joint 17 allows electrical power and electrical commands to be transmitted between the hull 2 and the lower part 7 of the sail 1 without limiting the number of rotations about the mast 3 that can be carried out with the sail. The joint 17 may also be replaced by a suitable conventional cable-bearing chain. When the power used to actuate the sail element according to the invention is, for example, hydraulic or pneumatic power, a rotary hydraulic or pneumatic joint can be used.

Amongst the various measurement sensors, there may be sensors for measuring the load transmitted from the sail 1 to the hull 2, sensors for measuring the load in the transverse axis of the hull 2, sensors for measuring load in the longitudinal axis of the hull 2, the sensor for pressure in the internal cavity of the sail 1, and the sensor that measures the speed and angle of the relative wind. This last measurement may equally well be taken on the sail 1 or on the hull 2. In instances in which the sensors are positioned on the part secured to the mast 3, they measure the loads along the longitudinal axis and the transverse axis of the sail 1.

The sail 1 may further comprise a sail neutralizer (not depicted) which would be stored in the sail receptacle 11 or in the headboard 10. Such a neutralizer, when deployed upwards from the bottom of the sail or downwards from the top of the sail, would allow the sail to be encapsulated, thus reducing its volume by expelling the internal air thus preventing it from luffing and reducing its windage.

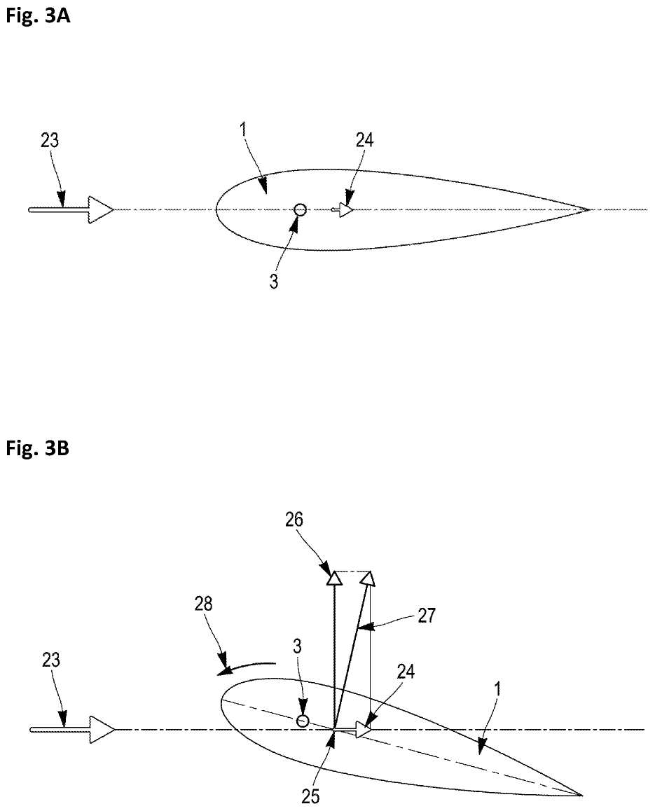

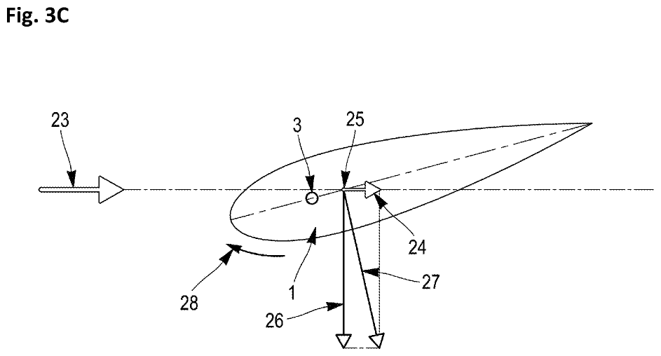

FIGS. 3A, B and C differ from one another by having a different sail angle of incidence.

In FIG. 3A, the relative wind is along the axis of the sail. In FIG. 3B, the axis of the sail is at an angle substantially equal to 15° with respect to the direction of the relative wind, and in FIG. 3C, the axis of the sail is at an angle symmetrical with and equal to that depicted in FIG. 3B with respect to the direction of the relative wind.

In FIGS. 3A, 3B and 3C, the sail 1 has a substantially symmetrical profile. The mast 3 is symbolized by a circle. The relative wind is symbolized by the arrow 23.

FIG. 3A depicts a sail 1 in a stabilized state facing into the wind 23. The various loadings are balanced. The aerodynamic lift is zero (because it is identical on both sides of the wing because of its symmetrical profile), there is only drag 24 which keeps the sail 1 on an axis parallel to the axis of the relative wind.

FIG. 3B depicts a sail 1 of which the axis is at an angle of around 15° with respect to the direction of the relative wind. The axis of rotation of the mast 3 is offset towards the front of the profile with respect to the centre of thrust 25 of the aerodynamic forces along the axis of symmetry of the profile. FIG. 3B shows that the torque generated by the aerodynamic force at a certain distance from the centre of rotation of the mast 3 has a tendency to return the sail towards its position facing into the relative wind, where it can remain stably thanks to the symmetrical profile of the sail.

The offset there is between the point of rotation of the mast 3 and the centre of thrust 25 allows the propulsion element of the invention to ensure that the sail 1 is held in place both in situations in which there is a large angular deviation from the direction of the wind and situations in which there is a small angular deviation. Such an offset between this point of rotation of the mast 3 and the centre 25 means that the sail 1 can be made to return towards the neutral position of the sail, which is to say the position facing into the wind, when the sail deviates from that position. Such an offset makes it possible to improve the safety of sailing since the sail automatically returns to a suitable and optimal position with respect to the direction of the relative wind, thereby minimizing load and keeping the sail facing into the wind. However, this distance needs to be minimized so as not to overly increase the forces needed for rotating the sail.

FIG. 3C is the figure symmetrical with that of FIG. 3B with respect to the axis of the relative wind. The same observations as those in respect of FIG. 3B apply.

### Example

The example which follows is given solely by way of illustration and is not limiting. The table below collates various possible situations.

| | Sailboat | Cargo vessel |
|---|---|---|
| Length of boat (in metres) | 2 | 100 |
| Number of sails | 1 | 4 |
| Sail internal layer in polyester | 220 | 240 |
| (g/m²) | | |
| Sail external layer in coated | 110 | 160 |
| polyester (g/m²) | | |
| Height of sail (in metres) | 17 | 40 |
| Longest length of sail (in metres) | 8 | 17 |
| Greatest width of sail (in metres) | 1.8 | 3.5 |
| Surface area of sail (m²) | 100 | 500 |
| Number of panels | 30 | 35 |

The external layer of the sail, also referred to as the body, is made from a woven fabric comprising an external part in contact with the exterior air, and an internal part. This fabric may be a woven polyester coated with polyurethane. The grammage of this fabric may be 110 g/m² for approximately 100 m² sail area.

The upper part of the sail may be secured using hook and loop strips of the Velcro type. The connections between the outer parts of the sail and the ribs (internal connections) and the connections between the constituent elements of the outer part may be achieved by fusion bonding or adhesive bonding or any other means of connection (zip-fasteners for example) which are able to ensure both a sufficiently low level of permeation compatible with the existing inflation system while also ensuring that load is transmitted.

1.-9. (canceled)

10. A sail propulsion element comprising:
a mast (3);
an inflatable sail (1) consisting essentially of two substantially fluidtight adjacent surfaces (5) joined together along a periphery of the surfaces, forming at least one closed cavity between the surfaces, the inflatable sail comprising an upper part (6), a lower part (7), a leading edge (8) and a trailing edge (9), and the inflatable sail comprising cambers forming bulges along an entire length of the inflatable sail, the inflatable sail having a center of aerodynamic thrust;
an air conduit positioned between an inside and an outside of the at least one closed cavity of the inflatable sail;
at least one means for injecting air into the at least one closed cavity, the inflatable sail once inflated having a profile that remains permanently symmetrical, irrespective of movement of the sail propulsion element, or of a direction or strength of wind;
a headboard (10) positioned on the upper part (6) of the inflatable sail (1); and
a sail receptacle (11) positioned between the leading edge (8) and the trailing edge (9) on the lower part (7) of the inflatable sail,
wherein the mast is located forward of the center of aerodynamic thrust of the inflatable sail,
wherein the mast is or is not free to rotate by 360°, and
wherein the inflatable sail comprises at least one means maintaining a slight pressure in the inflatable sail.

11. The sail propulsion element according to claim 10, wherein the center of aerodynamic thrust of the inflatable sail (1) is distant from the mast (3) by a length ranging from 0 to 10 m.

12. The sail propulsion element according to claim 10, wherein the at least one means for maintaining pressure is an air intake opening positioned facing into relative wind.

13. The sail propulsion element according to claim 10, wherein, during rotation of the mast, energy and commands are transmitted using a device that does not impede the rotation.

14. The sail propulsion element according to claim 13, wherein the device that does not impede the rotation is selected from a rotary joint or a cable bearing chain.

15. The sail propulsion element according to claim 12, wherein the air intake opening comprises a mobile closure flap.

16. The sail propulsion element according to claim 10 further comprising at least one guide line consisting of one or more parts positioned in the at least one closed cavity of the inflatable sail, for the maneuvers of hoisting and dropping the inflatable sail, the at least one guide line extending from the leading edge to the trailing edge of the inflatable sail, passing through the headboard and the sail receptacle.

17. A vehicle with sail or hybrid propulsion comprising at least one sail propulsion element according to claim 10, a hull and a mast (3) secured to the hull and free to rotate, wherein the mast (3) is positioned inside the at least one closed cavity of the inflatable sail.

18. The vehicle according to claim 17, wherein the inflatable sail is oriented according to a wind direction and according to a direction of running of the vehicle either manually or automatically.
